(19) United States
(12) Patent Application Publication
(10) Pub. No.: US 2016/0308410 A1
(43) Pub. Date: Oct. 20, 2016

(54) ELECTRIC MACHINE AND METHOD FOR PRODUCING AN ELECTRIC MACHINE

(71) Applicant: ROBERT BOSCH GMBH, Stuttgart (DE)

(72) Inventor: Reinhard Meyer, Bietigheim-Bissingen (DE)

(21) Appl. No.: 15/038,549

(22) PCT Filed: Nov. 10, 2014
(86) PCT No.: PCT/EP2014/074202

§ 371 Date: May 23, 2016

(30) Foreign Application Priority Data
Nov. 21, 2013 (DE) 10 2013 223 809.6

(51) Int. Cl. H02K 1/24; H02K 9/04; H02K 15/02; H02K 1/02

(52) U.S. Cl. CPC H02K 1/243; H02K 1/02; H02K 9/04; H02K 15/022

(57) ABSTRACT

The invention relates to an electric machine (10), in particular an electric machine (10) such as a generator or a motor, having at least one pole (22, 23) such as a salient pole or a claw pole, for converting mechanical energy into electrical energy, said electric machine comprising at least one rotor (20), which has at least two (claw) poles (22, 23) each made of a pole material, on the outer surface (100) of which 112 (claw) poles directed toward a stator bore at least one recess (110) is formed, wherein a filling material (120) is arranged in the recess (110), which filling material is less electrically conductive than the particular pole material and acts as a magnetic conductor.

### BACKGROUND OF THE INVENTION

The invention relates to an electric machine, in particular an electric machine such as a generator or a motor having a pole such as a salient pole or a claw pole for converting mechanical energy into electrical energy according to the preamble of claim 1.

Furthermore, the invention relates to a method for producing an electric machine that has reduced eddy current losses for converting mechanical energy into electrical energy, in particular for reducing eddy currents at a pole surface of an electric machine such as a generator or a motor having at least one pole such as a salient pole or a claw pole, during operation of the electric machine according to the preamble of claim 10.

The invention is based on an electric machine for converting mechanical energy into electrical energy or that is embodied in a reverse manner for converting electrical energy into mechanical energy according to the generic type of the independent claims.

Electric machines are the subject of the present invention, said electric machines being in particular motors and generators that have solid salient poles, by way of example claw pole generators, so as to supply d.c. voltage to vehicle electrical systems in motor vehicles.

Generators for converting mechanical energy into electrical energy in the motor vehicle are known from the prior art. Usually, generators are used that are equipped with an electrical excitation. These generators generate a.c. currents that are converted by way of a rectifier into d.c. current in order to use this current in d.c. current vehicle electrical systems in motor vehicles. Above all, a.c. current generators in the form of claw pole generators are used to generate energy in motor vehicles. The rotors of said generators comprise at least one rotor shaft, two claw poles, a pole core and an exciter winding. The complete pole core or parts of the pole core can be formed as one piece on one of the two claw poles or for example in each case a half of the pole core can be formed on the two claw poles, so that the pole claw does not represent an independent component. As the rotor shaft or the rotor rotates, said pole core rotates with respect to a stator. The rotor is guided on both sides by means of bearing plates in rolling bearings. If a d.c. current flows through an exciter winding in the rotor, a magnetic field is produced. As soon as the rotor rotates, the magnetic field induces an a.c. current in the stator windings. The pole core and the two claw poles are pressed onto the rotor shaft in the prior art. For this purpose, it is necessary for the claw poles and the pole core to have a bore hole in the middle. In the case of claw pole generators of this type, eddy current losses occur and these are to be avoided. In the case of these electric machines, grooves in a stator core cause flux fluctuations in the air gap between the stator and the rotor. These flux fluctuations produce eddy currents on the rotor surface of claw pole machines, to be more precise on the outer surfaces of the claw pole that are facing the stator and said eddy currents contribute to losses and thus to the rotor heating up. Particularly in the case of a small working air gap and high rotational speeds, such as occur in the case of claw pole generators, these eddy currents lead to significant losses and reduction in the efficiency level. The claw poles of motor vehicle generators are generally embodied from solid soft-magnetic steel that also has a high electrical conductivity characteristic, so that the eddy currents can easily form. Since in the case of high rotational speeds the centrifugal force requires a high mechanical strength in the claw pole, it is not possible to manufacture the claw pole in an optimal manner from an eddy current-resistant material.

It is generally known in the case of claw pole generators or Lundell generators to provide furrows in the surface of the claw poles that prevent the formation of eddy currents but that also increase the size of the middle air gap and consequently reduce the machine output in the lower rotational speed range. It is further known to coat claw poles, more precisely to coat the finger surface facing the stator, with a material that conducts the magnetic flux efficiently but has a poor electrical conductivity characteristic. However, the extent to which the coating adheres to the claw poles is limited in the case of high rotational speeds.

JP 05056615 discloses a claw pole generator having claw poles, wherein a groove is provided in the surface of said claw poles that face a stator. A material that has a low electrical resistance, in other words has a high or good electrical conductivity characteristic, by way of example copper or aluminum, is arranged in the groove so as to form a closed current circuit at the claw pole. The conductivity of copper at a temperature of approx. 300 K is approx. >=58.0 MS/m. The conductivity of aluminum at approx. 300 K is approx. 36.59 MS/m. A permeability number as an index for a magnetic conductivity characteristic is approx. slightly less than 1 (1−6.4×10⁻⁶) for copper and slightly higher than 1 (1+2.2×10⁻⁵) for aluminum. Consequently, the materials are materials that have a poor magnetic characteristic and a good electrical conductivity characteristic.

U.S. Pat. No. 5,903,084 likewise discloses a claw pole generator having claw poles, wherein a groove is provided in the surface of said claw pole generator that faces a stator. An electrical conductor is arranged in the grooves in such a manner that it encompasses the pole and said electrical conductor is embodied from a non-magnetic material, in other words from a magnetic material that has a permeability number in the region of 1 (vacuum, neutral).

Further electric machines of this type are inter alfa also disclosed in EP 2157679 A1, U.S. Pat. No. 6,396,181B1, DE 19502184A1, US 20040142189A1, U.S. Pat. No. 6,545,383B1, U.S. Pat. No. 7,525,233B2, JP2008220083A, DE 19711750 and JP 2011087340A.

### SUMMARY OF THE INVENTION

The electric machine in accordance with the invention and the method in accordance with the invention have the advantage in comparison to the prior art that in the case of an electric machine,

in particular in the case of an electric machine such as a generator or a motor having at least one pole such as a salient pole or a claw pole, by way of example a starter mechanism such as a starter, for converting mechanical energy into electrical energy, having at least one rotor that comprises at least two poles that are each embodied from a pole material, wherein at least one depression is formed in the outer surface of said rotor that is facing a stator bore hole, wherein a filler material is arranged in the depression and said filler material has an electrical conductivity characteristic that is lower than the respective pole material,—is embodied preferably as an electrical non-conductor or as a conductor that has a poor electrical conductivity characteristic—and functions as a magnetic conductor, the formation of eddy currents is avoided and at least the number of eddy currents formed is reduced without having to change a material that is optimized for the entire pole. By avoiding air gaps despite the presence of furrows, the number of eddy current losses that occur is advantageously reduced, so that furthermore the output of the electric machine is advantageously maintained to a great extent. One material is inter alia then not as good a conductor as another material if it has an electrical conductivity characteristic that is lower than that of another material. The electric machine in accordance with the invention is embodied in one embodiment for a generator mode as a generator, for a motor mode as a motor and for the two operating modes. Thus, not only is it possible to convert mechanical energy into electrical energy but also electrical energy can be converted into mechanical energy. The pole having the surface that is facing the stator bore hole is embodied in one embodiment in the form of a pole finger. It is preferred that more than one depression is provided in the surface. The depression is formed in one embodiment as a groove or a furrow. In another embodiment, the depression is embodied as a dent, a blind hole or another desired notch or recess. The filler material is preferably a solid filler material. By way of example, a filler material that hardens, in particular a filler material that self-hardens, is provided in another embodiment. The pole is preferably embodied as a solid pole. An iron material or an iron compound is preferably provided as the pole material. The pole materials for the different poles are preferably identical. The term ‘an electrical non-conductor’ is to be understood in terms of the present invention as a component or material that has an electrical conductivity characteristic that is less than that of the pole material. This term is understood to mean in particular materials that do not have an electrical conductivity characteristic or have an electrical conductivity characteristic that is practically insignificant, in other words their conductivity characteristic—preferably at 300 K—is less than an approximate threshold value of 20 MSm⁻¹. The term ‘a magnetic conductor’ is understood in terms of the present invention to mean a material that has a magnetic permeability number μr that is greater than 100, preferably greater than 1000. The materials are preferably material mixtures or material composites. A magnetic conductive material is in particular a material, a material mixture or a material composite that comprises a corresponding number of ferromagnetic materials. It is preferred that the pole material—iron material—that is used to produce the poles has an electrical conductivity characteristic in the region of 10 MS/m. The depressions comprise at least one opening in the surface. In another embodiment, the depressions are embodied as through-going openings, in other words a depression having multiple openings. In one embodiment, the cross-section of a depression is constant over the length of said depression. In another embodiment the cross-section of a depression varies over the length of said depression, by way of example continuously varying and/or varying in steps.

The rotor of the electric machine comprises in one embodiment at least two poles, by way of example two salient poles or two claw poles, a pole core and the rotor shaft. The rotor is preferably arranged in a stator bore hole so that an inner face of the stator bore hole faces an outer surface of the poles or said inner face lies opposite adjacent to said poles. The two poles are embodied in one embodiment as a salient pole and an opposite salient pole, referred to in short as an opposite pole. In one embodiment, the salient poles are embodied as claw poles. The pole core is surrounded by the two poles. In one embodiment, the pole and the opposite pole comprise a plurality of pole fingers, by way of example six, seven, eight or nine pole fingers, by way of example claw pole fingers. The number of pole fingers embodied on the pole is preferably identical to the number of pole fingers embodied on the opposite pole. It is preferred that an exciter winding is arranged on the pole core, said exciter winding also being surrounded by the poles, more precisely by the pole fingers of the pole and the opposite pole. The poles and the pole core are arranged on the rotatable rotor shaft. The rotor shaft is preferably in the form of a rod, by way of example a round rod having a round cross section.

In one embodiment, the pole core is embodied in an integrated manner in one of the two poles, in other words, the pole core and one pole are embodied as one piece. This component, in other words the pole having the pole core, is uninterrupted in the radial and axial direction, wherein the directional specifications radial and axial relate to a longitudinal extension of the rotor shaft. The other second pole or the opposite pole is embodied in one embodiment separately from the pole core having the integrated pole and is connected thereto. Furthermore, in one embodiment, the rotor shaft is embodied in an interrupted manner at least in the region of the poles, in other words is embodied at least in two parts.

It is provided in one embodiment that the depression is embodied as a depression comprising at least one undercut so as to fix the filler material that is arranged in the depression. The depression comprises an opening that is open outwards in the radial direction, in other words in a radial direction towards a surrounding stator. Since the rotor rotated about the axis of rotation, also at high rotational speeds, a centrifugal force acts on a filler material that is arranged in the depression and said material is inclined as a result to move out of the depression. As a result of at least one undercut in the depression in which the filler material is arranged at least in part, said filler material is hindered in moving outwards in the radial direction. The undercut can be formed in any desired manner. In one embodiment, a dove tail-shaped undercut is provided. In other embodiments, cuts and/or bulges are provided in a transverse manner with respect to the direction of extension of the depression.

Another embodiment of the present invention provides that the filler material lies in a maximal flush manner with the edge of the depression so as to ensure a surface that does not protrude. In other words, the filler does not protrude out of the depression in the direction of the surface beyond the depression and consequently the surface. It is preferred that the filler material that is located in the respective depression lies flush with the surface around the relevant depression. In this manner, an air gap between the surface and the surrounding stator is minimized. In another embodiment, a surrounding region of the surface around the depression is coated with the filler material.

Yet a further embodiment provides that the filler material and/or the depression is provided with an adhesive medium so as to ensure that the filler material fixes in the depression in an improved manner. In addition to an undercut or as an alternative thereto, the filler material is adhered to a wall of the respective depression, preferably using an adhesive medium such as adhesive or the like. It is preferred that the adhesive medium is embodied as an adhesive layer. Since the filler material can also be embodied as a material mixture, the adhesive medium in integrated in one embodiment in the material mixture or generally into the filler material. Thus, powder-like material mixtures that are embodied by way of example by means of integrated media that adhere together and/or adhere to a wall can also be used as the filler material.

Accordingly, it is provided in a further embodiment that the filler material is embodied as a powder material, in particular a compressed powder material and/or as a material that can deform at least in part in a plastic manner in the depression. A powder material that is embodied by way of example as a powder mixture or a powder composite material can be introduced in a simple manner into any depression. After being introduced, the powder material can be compressed with the depression by means of being pressed in said depression. Consequently, a powder material that is compressed in the depression is used as a filler material. Powder materials are advantageous particularly in depressions that comprise an undercut. The required characteristics—magnetic conductors and electrical non-conductors—can be easily adjusted as a mixture in the case of a powder material by virtue of corresponding mixtures, inclusions, dosages or the like.

It is provided in an advantageous embodiment that the filler material has an electrical conductivity characteristic less than or equal to 5 MS/m, preferably less than or equal to 3 MS/m and most preferably less than or equal to 1 MS/m and/or a magnetic conductivity characteristic, expressed in a permeability number, approx. greater than or equal to 100, more preferably greater than or equal to 300 and most preferably greater than or equal to 500, and is embodied in particular as a powder composite material having a permeability number greater than 600. The powder composite material or also soft-magnetic composite—or in short SMC—is embodied by virtue of a corresponding composite. In one embodiment, this also comprises, in addition to ferromagnetic components, adhesive components and/or magnetic conductive components.

In addition, it is provided in one embodiment that the spacings, the shape and/or the depth of multiple depressions vary over the surface for each pole. In one embodiment, all depressions are formed in an identical manner, in other words said depressions have essentially an identical shape, identical depth, identical cross section, identical loading capacity etc. In another embodiment, the depressions have a different length, in other words said depressions extend along the surface to a different extent in the transverse and/or longitudinal direction. In other embodiments, the depth of the depressions is different. In further other embodiments, the cross sections of the depths are different.

Furthermore one embodiment provides that the depression is embodied as at least one groove, in particular as at least one groove that ends in a transverse manner with respect to an axial direction of the electric machine, in particular as multiple parallel groves and or as groove sections that are embodied in a spiral-shaped manner. The groove sections can be milled and/or turned by way of example in the surface. Spiral-shaped sections can be preferably formed by means of a turning method. The groove extends preferably over an entire width of the surface, in other words in the circumferential direction. The groove or groove sections are embodied in one embodiment in a transverse manner with respect to a circumferential direction and/or an axial or longitudinal direction. In another embodiment, the grooves extend in the longitudinal direction. In further other embodiments, the grooves extend in directions which are different. This renders it possible by way of example to achieve grooves that extend and are arranged in a grid-like manner. A cross section of a groove is by way of example approx. rectangular, oval, U-shaped or similar. A cross section is preferably embodied with an undercut.

Last but not least, it is provided in one embodiment that the depression is filled with the filler material up to at least 70 volume %, more preferably up to at least 80 volume % and most preferably up to at least 90 volume %. It is preferred that the depression is filled to 100 volume %. Air pockets are provided in other embodiments. One embodiment provides that the filler material contacts at least in part a depression bottom or depression base. In another embodiment, it is provided that the filler material does not contact the depression bottom. In a further embodiment, air pockets are provided, by way of example so that two sections of filler material are formed that are separated by the air pocket. In a further embodiment, it is provided that the filler material is arranged at least in part in an undercut of the depression. It is preferred that an air pocket is not provided between the filler material in an undercut and the filler material that is arranged in the direction towards the surface.

The method in accordance with the invention having the features of the corresponding main claim has the advantage in comparison to the prior art that in the case of a method for producing an electric machine that has reduced eddy current losses for converting mechanical energy into electrical energy, in particular for reducing eddy currents at a pole surface of an electric machine such as a generator or a motor having a pole such as a salient pole or a claw pole, during an operation of the electric machine, wherein at least one rotor is provided that comprises at least two solid pole fingers and at least one depression is formed on the radial outer rotor surface of said rotor that is facing a stator bore hole, wherein a filler material is arranged in the depression, said filler material functioning as an electrical non-conductor or as a poor electrical conductor and a magnetic conductor, the formation of eddy currents is avoided or at least the number of eddy currents formed is reduced without having to change a material that is optimized for the entire pole. Existing poles can be easily retrofitted. Poles that are in accordance with the prior art are provided with a corresponding depression by way of example by means of turning, milling and the like method. A filler material is subsequently introduced into the depression. In order to provide adhesion, a corresponding adhesive medium is provided, wherein said adhesive medium is provided on a wall and/or on and/or in the filler material itself. In one embodiment, a powder-like filler material, by way of example SMC, is introduced into the depression. This powder-like filler material is then compressed in the depression so that the filler material is arranged in a reliable manner in the depression. In one embodiment, the filler material is introduced at least in part into an undercut of the depression. A yet further embodiment provides that the filler material is adjusted or mixed according to the required characteristics, in that by way of example ferromagnetic components having magnetic conductive components and/or an adhesive medium are mixed and/or embodied as a composite.

In order to reduce the output loss through the furrows or grooves in the pole surface, the depressions or recesses that are embodied as furrows or grooves are filled with a poor electrical conductor material and a good magnetic conductive material—for example a compressed powder material such as SMC. If the grooves on the pole surface have a suitable cross sectional geometry, by way of example cross sections that have an undercut, a powder material that is pressed and/or adhered into the grooves also remains in the grooves in the case of high rotational speeds—approx. in the region of 20.000 U/min. The grooves are filled maximal up to their edge with the filler material or filler described above.

### BRIEF DESCRIPTION OF THE DRAWINGS

Exemplary embodiments of the invention are illustrated in the drawings and further explained hereinunder. In the drawings;

FIG. 1 illustrates a cross-sectional view of an electric machine that is embodied as a claw pole generator,

FIG. 2 illustrates a cross-sectional view of a part of a claw pole generator having a rotor and claw poles,

FIG. 3 illustrates a cross-sectional view of a claw pole having claw pole fingers,

FIGS. 4a, 4b, 4c, 4d, 4e and 4f illustrate cross-sectional views of different cross-sections of a depression in a surface of a claw pole finger, and

FIGS. 5a, 5b, 5c and 5d illustrate a plan view of different depressions on a surface of a claw pole finger.

### DETAILED DESCRIPTION

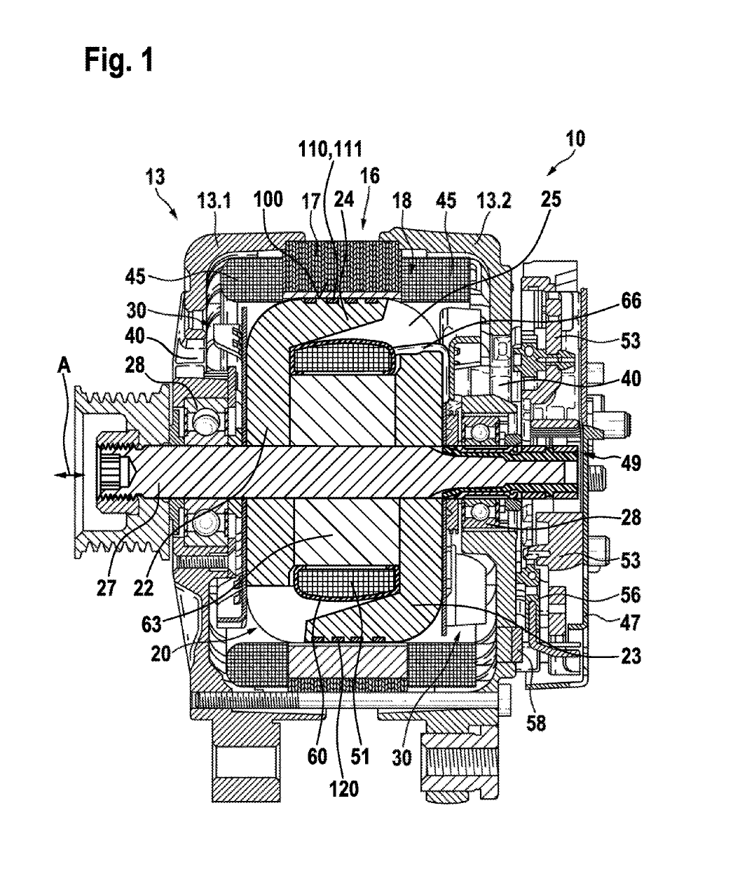

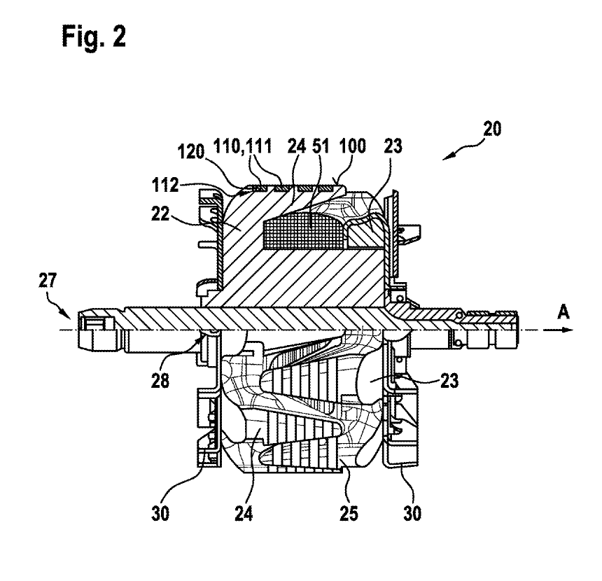

FIG. 1 illustrates a cross-sectional view of an electric machine 10 that is embodied as a claw pole generator, more precisely a cross-sectional view through an electric machine 10 that is embodied in the embodiment illustrated in the figure as a claw pole generator for motor vehicles for converting mechanical energy into electrical energy. The electric machine 10 comprises a two-piece housing 13 that comprises a first bearing plate 13.1 and a second bearing plate 13.2. The bearing plate 13.1 and 13.2 receive a so-called stator 16 that comprises an essentially annular stator core 17 and (protruding) stator windings 18 are placed or drawn in the radially inwards directed, axially extending grooves of said stator core. This annular stator 16 with its radially inwards directed, grooved surface surrounds a rotor or rotor 20 that is embodied as a claw pole rotor (not illustrated in the figure in detail). The rotor 20 comprises a pole 22, which is embodied as a claw pole, and an opposite pole 23 (cf. also FIG. 2) that are described also as pole boards, in this case claw pole boards, wherein in each case pole fingers 24 and 25 (in this case claw pole fingers, also described as poles) that extend in the axial direction are arranged on the outer circumference of said boards (cf. also FIG. 2). In the assembled state, the claw pole 22 and the opposite pole 23 are pressed one against the other so that their (claw) pole fingers 24 or 25 that extend in the axial direction are arranged alternately around the circumference of the rotor 20. As a consequence, magnetically required intermediate spaces are provided between the (claw) pole fingers 24 and 25 that are magnetized in opposite directions and are described as (claw) pole intermediate spaces. The (claw) pole fingers comprise a radial outer surface 100 that faces a stator inner face. Depressions 110 that are described in detail with reference to other figures are provided in this surface 100. The rotor 20 is rotatably mounted in the respective bearing plate 13.1 or 13.2 by means of a rotor shaft 27 and a rolling bearing 28 that is located in each case on each side of the rotor shaft.

The rotor 20 comprises two axial end faces and a fan 30 is attached to each said end face. This fan 30 comprises essentially a plate-shaped or disc-shaped section starting from the fan blades. The fan 30 is used so as to render it possible by way of openings 40 in the bearing plates 13.1 and 13.2 to exchange air between the outer side of the electric machine 10 and the inner space of the electric machine 10 so as to achieve cooling by means of air. For this purpose, the openings 40 are provided essentially on the axial ends of the bearing plates 13.1 and 13.2 and cooling air is drawn into the inner space of the electric machine 10 by way of said openings by means of the fan 30. This cooling air is accelerated radially outwards as a result of the fan 30 rotating so that said cooling air can pass through a cooling air-permeable winding overhang 45. The winding overhang 45 is also cooled as a result of this effect. After the cooling air has passed through the winding overhang 45 or has flowed over the winding overhang 45, said cooling air passes in the radial direction through the openings to the outside.

A protective cap 47 is illustrated on the right-hand side in FIG. 1, the various components of the rotor 20 are protected against environmental influences and contamination. The protective flap 47 covers a so-called slip ring assembly 49 that is used so as to supply an exciter winding 51 with an energizing current. A heat sink 53 that acts in this case as a positive heat sink is arranged around this slip ring assembly 49. The bearing plate 13.2 acts as a so-called negative heat sink. A connecting plate 56 is arranged between the bearing plate 13.2 and the heat sink 53 and said connecting plate is used so as in the heat sink 53 to connect to one another negative diodes 58 that are arranged in the bearing plate 13.2 and positive diodes that are not illustrated in the figure and consequently to represent a bridge connection that is known per se.

A coil carrier 60 is arranged radially outside a pole core 63. The object of the coil carrier 60 is to insulate the exciter winding 51 both with respect to the (claw) pole boards 22 and 23 and on the other hand during the course of pre-fabrication to act as a form-shaping element, quite particularly after the winding procedure with regard to the exciter winding wire is terminated. The coil carrier 60 is pushed with two connecting conductors 66 in the axial direction over the pole core 63 and subsequently axially fixed between the two (claw) pole boards 22 and 23.

Furthermore, the (claw) pole fingers 24 and 25 engage over the exciter winding 51 and thus form in the radially outwards direction a type of cage that prevents the exciter winding 51 from being inadmissibly displaced in the radial direction. The pole core 63 can also be subdivided in the axial direction into two sections that are formed as one on the (claw) pole boards 22 and 23. The pole core length is calculated from the total of the individual sections of the pole cores.

FIG. 2 illustrates in a cross-sectional view a part of the claw pole generator with a rotor 20 and (claw) poles 22, 23. The embodiment in FIG. 2 essentially corresponds to the embodiment in FIG. 1 already described. A second description of components that have already been described is therefore omitted. Identical components are identified with identical reference numerals. The section of the electric machine 10 illustrates essentially the rotor 20 with the rotor shaft 27. The rotor shaft 27 is embodied as one piece. The rotor shaft 27 comprises a round cross section. It extends in the axial direction A of the rotor 20. In the assembled state illustrated here of the rotor 20, the (claw) pole 22 and the opposite pole 23 are connected in a non-rotatable manner to the rotor shaft 27 by means of being pressed onto said rotor shaft. The (claw) pole fingers 24 and 25 comprise the radially outer surface 100 that is facing the stator 16 (cf. FIG. 1). This surface is at a constant radial spacing in the circumferential direction, in other words along the surface 100, with respect to the axis of rotation A of the rotor 20. Radially inwards extending depressions 110 are arranged in the surface 100. Said depressions are embodied in accordance with FIG. 2 as furrows or grooves 111. These comprise in the circumferential direction a constant, in this case rectangular, cross section 112. A filler material 120 is provided in the depressions 110. The filler material 120 functions as an electrical non-conductor and a magnetic conductor so as to prevent or reduce the formation of eddy currents, in particular on the surface 100. For this purpose, the filler material 120 lies flush with an edge of the depression 110 so as to ensure a surface 100 that does not protrude. The structure of the depressions 110 and of the filler material 120 is described in detail hereinunder.

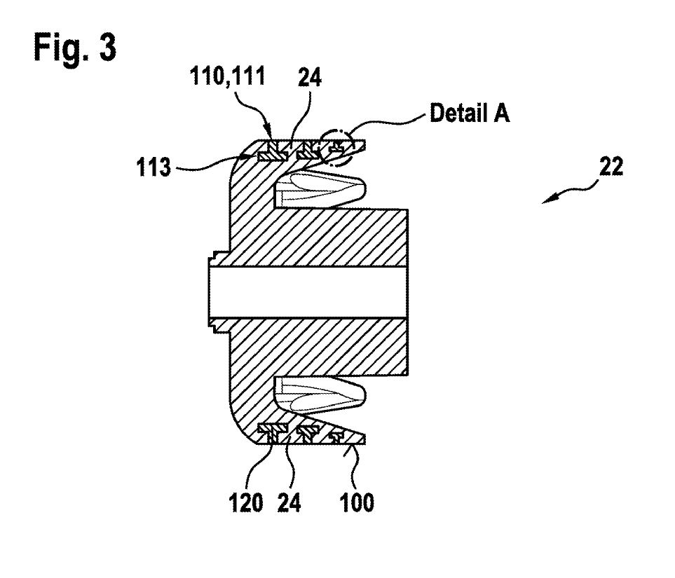

FIG. 3 illustrates a cross sectional view of a (claw) pole 22 with (claw) pole fingers 24. The depressions 110 are introduced into the surface 100. The filler material 120 is arranged in the depressions 110. The identical filler material 120 is provided in each depression 110. In other embodiments, different filler materials 120 are provided for different depressions 110. The depressions 110 are embodied as depressions 110 that comprise in each case an undercut 113, more precisely said depressions are embodied in each case as a groove 111 that comprises an undercut 113. The grooves 111 are completely filled with the filler material 120. The filler material 120 is embodied in this case as a filler material 120 that has an electrical conductivity characteristic less than or equal to 5 MS/m, preferably less than 3 MS/m and most preferably less than 1 MS/m and a magnetic conductivity characteristic, expressed in a permeability number, approx. greater than or equal to 100, more preferably greater than or equal to 300 and most preferably greater than or equal to 500. More precisely, the filler material 120 is embodied as a powder composite material that has a permeability number greater than 600. The filler material 120 is fixed on the one hand by means of being pressed in, inter alfa into the undercut in the depression 110. On the other hand, an adhesive medium is provided as is illustrated hereinunder.

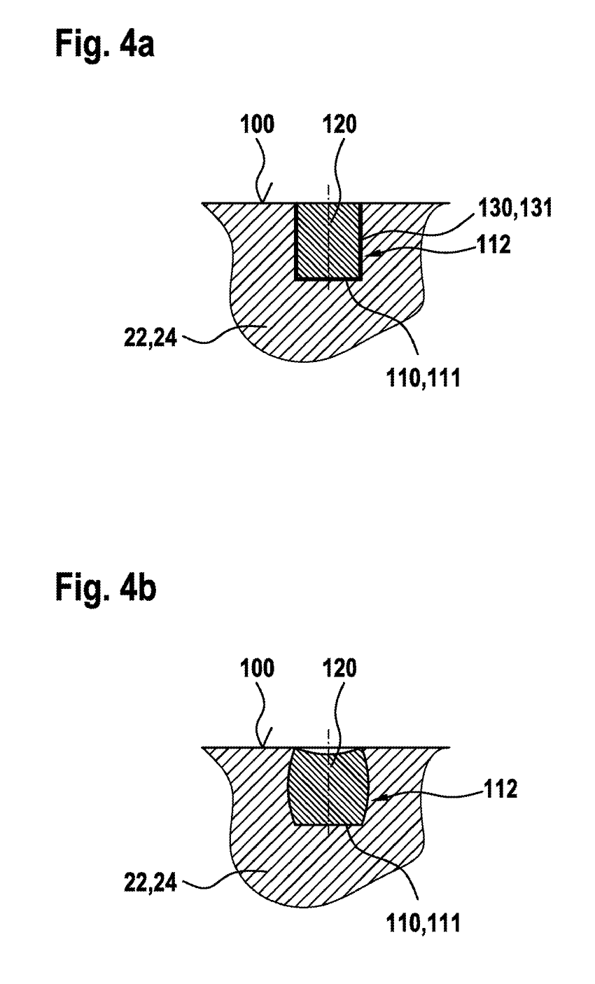

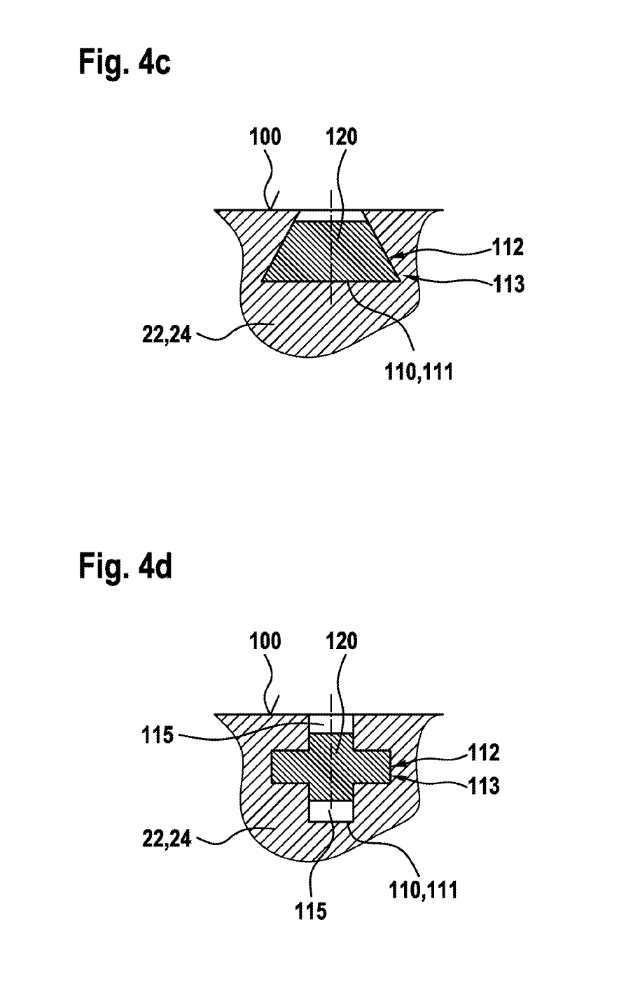

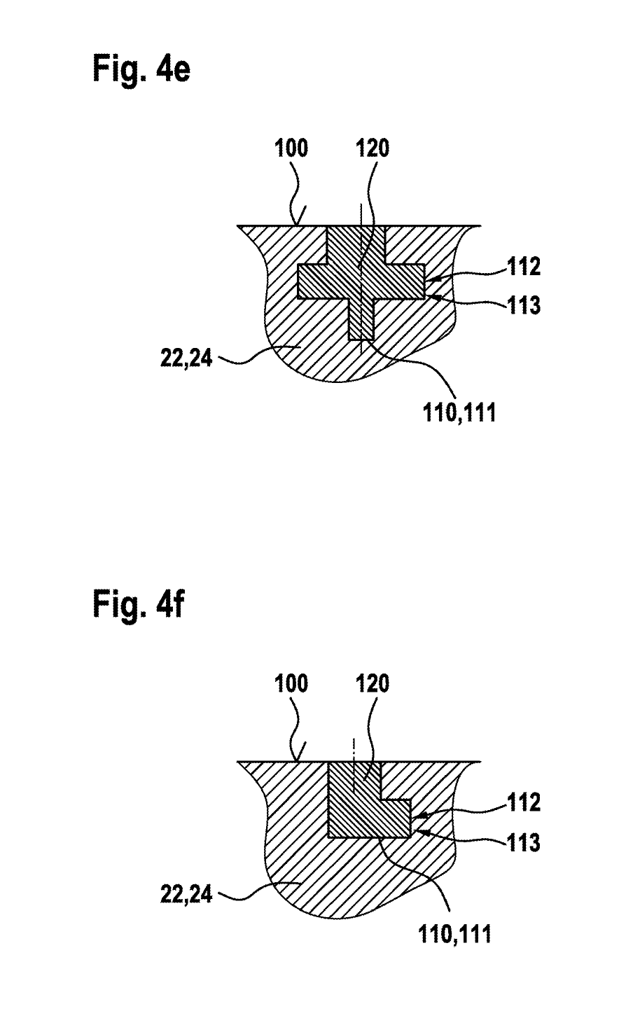

FIG. 4 illustrates cross sectional views of different cross sections 112 of a depression 110 in the surface 100 of a (claw) pole (finger) 22 (24). FIG. 4a illustrates a depression 110 that is embodied as a groove 111 having a rectangular cross section 112. The filler material 120 is fixed in the groove 111 by way of an adhesive medium 130 that forms an adhesive layer 131. The filler material 120 lies flush with the surface 100 so that a surface 100 is formed that does not protrude. FIG. 4b illustrates another cross section 112. The cross section 112 illustrated in 4b is approx. barrel-shaped. In this case, the filler material 120 is not filled completely up to an edge of the depression 110 or of the surface 100. FIG. 4c illustrates a depression 110 having an undercut 113. The illustrated depression 110 is embodied as a dove tail groove. As illustrated in FIG. 4b, the filler material 120 is not filled up to an upper edge of the depression 110 or of the surface. FIG. 4d illustrates a cross section 112 that is approximately in the shape of a cross and consequently likewise comprises an undercut 113. The undercut 113 is however not arranged adjacent to a base of the groove 111 but rather is arranged at a distance therefrom. The filler material 120 is arranged at a distance from the upper edge or from the surface 100 and the base of the groove 111 so that in each case there is a free space 115 adjacent to the base or the surface 100. The cross sections 112 according to FIGS. 4a to 4d are embodied in a mirror symmetrical manner. The FIGS. 4e and 4f illustrate mirror-asymmetrical cross sections 112. A modified, cross-shaped cross section 112 is illustrated in 4e. The undercut 113 extends differently in the transverse direction. A width of an upper depression section is different to a width of the lower depression cross section. The depression sections are separated from one another by means of the undercut 113. In FIG. 4f, the undercut 113 is embodied only on one side. The undercut 113 protrudes from an otherwise rectangular cross section 112 in a groove-like manner in one direction. The illustrated cross sections 112 represent by way of example only one section of a number of feasible cross sections 112.

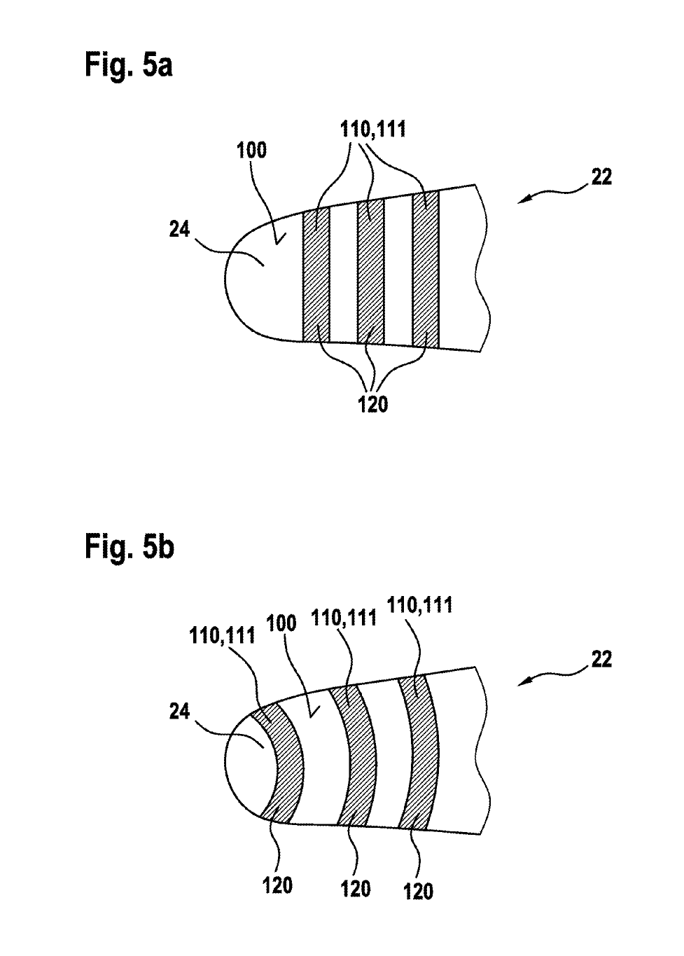

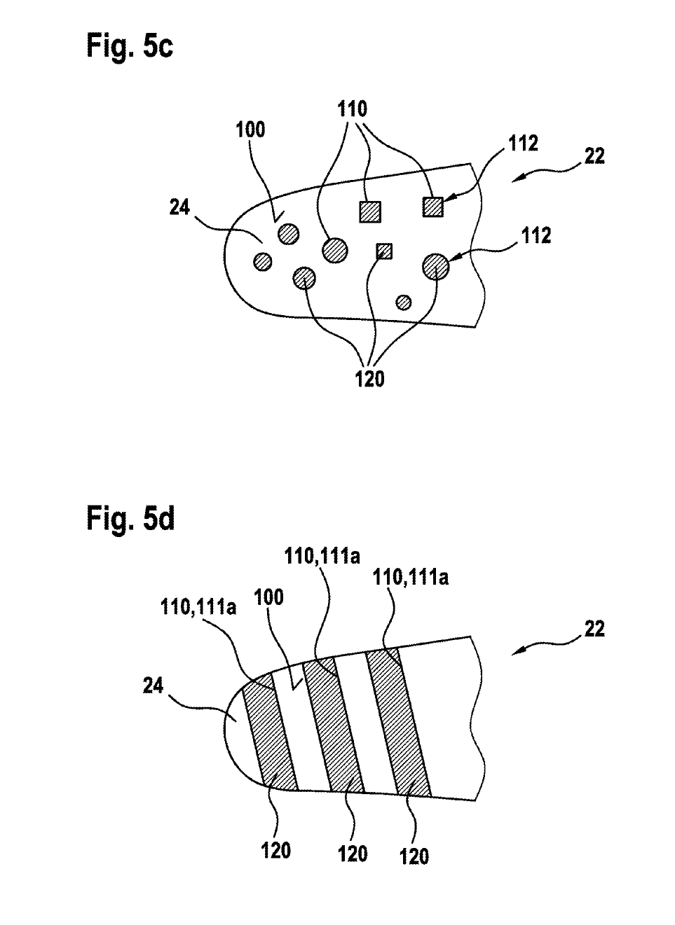

FIG. 5 illustrates a plan view of different depressions 110 in a surface 100 of a (claw) pole finger 24. The depressions 110 in FIG. 5a are embodied as grooves 111 and extend parallel and equidistant with respect to one another over the entire width of the surface 100. The (claw) pole finger 24 is embodied in a tapering manner. Consequently, the groove 111 that lies closest to a claw pole finger tip has a shorter length than the grooves 111 that are further away. The grooves 111 are filled completely with the filler material 120 that lies flush with respect to all openings of the respective groove 111 with the corresponding surface 100. The grooves 111 in FIG. 5b in contrast to those in FIG. 5a do not extend in a linear non-curved manner but rather extend in a slightly curved manner. Furthermore, the spacing between the grooves 111 is not constant but rather varies. The depressions 110 in FIG. 5c are not embodied as grooves 111 but rather are embodied in the form of blind bore holes. These have different cross sections 112—circular, rectangular. The cross sections 112 do not change in the radial direction but rather are embodied in a constant manner. In other embodiments, the cross sections change in the radial direction, in other words from the surface 100 towards the axis of rotation A so that by way of example a conical depression is formed. The arrangement of the depressions 110 in the surface 100 can be selected as desired. The spacings of the depressions 110 with respect to one another vary along a surface plane from depression 110 to depression 110. In FIG. 5d, a depression arrangement is provided that extends in an approximate spiral-shaped manner, such as in the form of a record disc groove. Accordingly, multiple spiral-shaped groove sections 111a or spiral sections are provided. The illustrated embodiments also represent in this case by way of example only one section of any number of selectable embodiments.

1. An electric machine (10) having a rotor (20) that comprises at least two poles (22, 23) that are each embodied from a pole material, wherein at least one depression (110) is formed in a surface (100) of said poles that faces a stator bore hole, characterized in that a filler material (120) is arranged in the depression (110) and said filler material has an electrically conductive characteristic that is lower than the electrically conductive characteristic of the respective pole material and functions as a magnetic conductor.

2. The electric machine (10) as claimed in claim 1, characterized in that the depression (110) that comprises at least one undercut (113) so as to fix the filler material (120) that is arranged in the depression (110).

3. The electric machine (10) as claimed in claim 1, characterized in that the filler material (120) lies in a maximal flush manner with the an edge of the depression (110) or of the surface (100) so as to ensure a surface that does not protrude.

4. The electric machine (10) as claimed in claim 1, characterized in that at least one of the filler material (120) and the depression (110) is provided with an adhesive medium (130) so as to ensure the filler material (120) is fixed in the depression (110).

5. The electric machine (10) as claimed in claim 1, characterized in that the filler material (120) is embodied as a powder material.

6. The electric machine (10) as claimed in claim 1, characterized in that the filler material (120) has an electrical conductivity characteristic less than or equal to 5 MS/m.

7. The electric machine (10) as claimed in claim 1, characterized in that the spacings, a shape and/or a depth of multiple depressions (110) vary across the surface (100) of each pole (22, 23).

8. The electric machine (10) as claimed in claim 1, characterized in that the depression (110) is embodied as at least one groove (111).

9. The electric machine (10) as claimed in claim 1, characterized in that the depression (110) is filled with filler material (120) up to at least 70 volume %.

10. A method for producing an electric machine (10) that has reduced eddy current losses for converting mechanical energy into electrical energy, the method comprising providing at least one rotor (20) that comprises at least two poles (22, 23) that are embodied in each case from a pole material, forming at least one depression (110) on a radial outer surface (100) of said rotor that faces a stator bore hole, and arranging a filler material (120) in the depression (110) wherein said filler material has an electrical conductivity characteristic that is lower than the the electrical conductivity characteristic of the respective pole material and functions as a magnetic conductor.

11. An electric machine (10) comprising a rotor (20) having at least two poles (22, 23) for converting mechanical energy into electrical energy, the at least two poles (22, 23) being embodied from a pole material, wherein at least one depression (110) is formed in a surface (100) of said poles that faces a stator bore hole, wherein a filler material (120) is arranged in the depression (110) and said filler material has an electrically conductive characteristic that is lower than the electrically conductive characteristic of the respective pole material and functions as a magnetic conductor.

12. The electric machine (10) as claimed in claim 1, characterized in that the filler material (120) is embodied as a compressed powder material.

13. The electric machine (10) as claimed in claim 1, characterized in that the filler material (120) is embodied as a material that can deform at least in part in a plastic manner in the depression (110).

14. The electric machine (10) as claimed in claim 1, characterized in that the filler material (120) has an electrical conductivity characteristic less than or equal to 3 MS/m.

15. The electric machine (10) as claimed in claim 1, characterized in that the filler material (120) has an electrical conductivity characteristic less than or equal to 1 MS/m.

16. The electric machine (10) as claimed in claim 1, characterized in that the filler material (120) has a magnetic conductivity characteristic, expressed in a permeability number, greater than or equal to 100.

17. The electric machine (10) as claimed in claim 1, characterized in that the filler material (120) has a magnetic conductivity characteristic, expressed in a permeability number, greater than or equal to 300.

18. The electric machine (10) as claimed in claim 1, characterized in that the filler material (120) has a magnetic conductivity characteristic, expressed in a permeability number, greater than or equal to 500.

19. The electric machine (10) as claimed in claim 1, characterized in that the filler material (120) has a magnetic conductivity characteristic, expressed in a permeability number, greater than 600 and is embodied as a powder composite material.

20. The electric machine (10) as claimed in claim 1, characterized in that the depression (110) is embodied as at least one groove (111) that extends in a transverse manner with respect to an axial direction (A) of the electric machine (10).

21. The electric machine (10) as claimed in claim 1, characterized in that the depression (110) is embodied as multiple parallel grooves (111) that extend in a transverse manner with respect to an axial direction (A) of the electric machine (10).

22. The electric machine (10) as claimed in claim 1, characterized in that the depression (110) is embodied as groove sections (111a) that are embodied in a spiral-shaped manner.

23. The electric machine (10) as claimed in claim 1, characterized in that the depression (110) is filled with filler material (120) up to at least 80 volume %.

24. The electric machine (10) as claimed in claim 1, characterized in that the depression (110) is filled with filler material (120) up to at least 90 volume %.
